(19) United States
(12) Patent Application Publication
(10) Pub. No.: US 2013/0076871 A1
(43) Pub. Date: Mar. 28, 2013

(54) HIGH SPEED PHOTOMETRIC STEREO PAVEMENT SCANNER

(71) Applicant: Bryan Reeves, Chapel Hill (AU)

(72) Inventor: Bryan Reeves, Chapel Hill (AU)

(73) Assignee: RADAR PORTAL SYSTEMS PTY LTD, Seventeen Mile Rocks (AU)

(21) Appl. No.: 13/514,882

(22) PCT Filed: Dec. 7, 2010
(86) PCT No.: PCT/AU2010/001648

§ 371 Date: Jun. 8, 2012

(30) Foreign Application Priority Data
Dec. 8, 2009 (AU) 2009245853

(51) Int. Cl. G01B 11/25

(52) U.S. Cl. CPC G01B 11/25
USPC 348/50

(57) ABSTRACT

The invention relates to a pavement scanning system having a movable platform, multiple light sources mounted on the platform for illuminating a pavement surface from multiple different angles, at least one image capture device mounted on the platform that captures sequential images of the illuminated pavement surface and a movement sensor that encodes movement of the platform and provides a synchronization signal for synchronizing the multiple light sources and the at least one image capture device for multiple image capture. The pavement scanning system also includes at least one processor that resamples the multiple captured sequential images to compensate for difference in collection time and calculates surface gradient and albedo for each point on the pavement surface or directly uses the multiple images to detect surface features.

### FIELD OF INVENTION

This invention relates to a high speed surface digitization system that allows accurate detection and assessment of surface profiles. The invention can be applied to the assessment of road pavements, bridge decks and airport runways.

### BACKGROUND OF THE INVENTION

To allow timely maintenance of road pavements, an accurate identification and assessment of road pavement surface distress is required. There are many different modes of distress that can occur, including but not limited to cracking, delamination, disintegration and deformation. Once the type, extent, location and severity of each of these features are assessed, the condition of the road can be determined and remedial measures applied to fix these problems. It is also important to identify areas of both low roughness, which can result in low skid resistance, and high roughness which can result of pavement distress.

Since the early 1970's, a number of systems have been built to allow the assessment of road pavement condition. These can be roughly characterized into two areas:
1) Camera imaging systems, which record a view of the road surface that is then either manually or automatically assessed.
2) Profiling systems, which normally use lasers, ultrasound or mechanical means to determine a digital elevation map (DEM) of the road surface.

Camera imaging systems (which include linescan camera systems) allow accurate imaging of the road surface, often to quite high resolution. While manual assessment of these images is quite reliable, automated assessment of the road surface using these images is often quite difficult. This is partially because road markings, such as oil spills, paint marks, lane markings, tire marks and other road debris, can be easily mistaken for surface distress.

A profiling system produces a profile at fixed intervals along the road, or for a fixed number of lines down the road. As a result they do not measure the entire road surface, and thus are normally not used for crack detection as they will miss a high percentage of the cracks and/or features on the road. However, they can easily produce automated readings, such as road roughness measures.

Photometric stereo is a technique for capturing a surface, where a local estimate is made of the surface orientation through the use of several images of the same surface and same viewpoint, but under illumination from different directions. It was first introduced by Woodham in 1980 [Woodham], and has since been used in a variety of areas, including detecting fingerprints, indented handwriting, assessment of oil painting and the classification of surface roughness.

In the simplest form of the technique [Woodham], three images of the surface are taken with a standard camera, with three different lighting directions. These image intensities are combined with the lighting direction vectors to separately determine the surface albedo (or reflectivity), and the two surface gradients components (the shape of the surface). The separation of the surface reflectance from the shape of the surface allows a more detailed assessment of the surface that cannot be obtained using just a single image.

For a three light source model, the following steps are performed:
a) For each given point (x, y) on the surface, the image intensity vector i is firstly formed by capturing three images under different illumination directions L₁, L₂ and L₃.
b) The vector M=[m₁, m₂, m₃]^{T} is obtained by the production of I and L⁻¹.
c)The surface gradient components can be calculated via

p=−m₁/m₂ and q=−m₂/m₃
d) Finally, the surface albedo is recovered by finding the length of vector M.

p=scrt(m₁²+m₂²+m₃²)

where,
I=[i₁, i₂, i₃]^{T} is image intensity vector,
L=[L₁, L₂, L₃]^{T} is photometric illumination matrix which incorporates the light intensity for each light source.

With four (or more) light sources, an improved estimate of the surface gradients can be achieved. The goal is to remove the effect of shadowed and specular reflections. In the simplest form of this, the three brightest pixels are used to estimate the surface derivatives, thus removing many of the areas of high shadow.

Photometric stereo has been used for small-scale assessment of road surface condition [Shalaby et al]. The system uses a conventional camera with four single point light sources, and is not designed for high-speed operation. The technique is used to characterize pavement surface textures.

Techniques similar to photometric stereo have also been used for inspection of objects on a conveyor belt using both individual photo-sensors (U.S. Pat. No. 3,892,492) or using a line-scan camera (U.S. Pat. No. 6,166,393 and U.S. Pat. No. 6,327,374). These systems rely on a number of colored lights to identify surface color, in conjunction to surface gradients. They are also specifically designed to identify defective rapidly moving objects moving on a convey6r belt past a stationary sensor system, rather from a moving platform for road pavement evaluation.

### REFERENCES

Woodham, R. J., “Photometric Method for Determining Surface Orientation from Multiple Images”.Optical Engineering 19(1) 139-144 (1980).

Shalaby et al., “Image Requirements for Three-Dimensional Measurements of Pavement Macrotexture”, Journal of the Transportation Research Board, Issue Volume 2068/2008, ISSN 0361-1981.

Paul D. et al. U.S. Pat. No. 6,166,393, “Method and Apparatus for Automatic Inspection of Moving Surfaces”.

Pirronen, T. H. et at. U.S. Pat. No. 6,327,374, “Arrangement and Method for Inspection of Surface Quality”.

Eichenberger, Werner, U.S. Pat. No. 3,892,492, “Optoelectrical Apparatus with Directional Light Sources for Detecting Reflecting Behaviour of an Object”.

### OBJECT OF THE INVENTION

It is therefore an object of the present invention to provide a road surface digitizing system that overcomes some of the disadvantages of the prior art or at least provides a useful alternative.

### STATEMENT OF THE INVENTION

In one form, although it need not be the only or indeed the broadest form; the invention resides in a pavement scanning system comprising:
a movable platform;
multiple light sources mounted on the platform for illuminating a pavement surface from multiple different angles;
at least one image capture device mounted on the platform that captures sequential images of the illuminated pavement surface;
a movement sensor that encodes movement of the platform and provides a synchronisation signal for synchronising the multiple light sources and the at least one image capture device for multiple image capture; and
at least one processing means that:
   resamples the multiple captured sequential images to compensate for difference in collection time; and
   calculates surface gradient and albedo for each point on the pavement surface.

In another form, the invention resides in a method of detecting pavement deterioration including the steps of:
illuminating a pavement surface from multiple angles with multiple light sources;
capturing images of the illuminated surface;
synchronising image capture with the surface illumination;
processing the captured images to:
   correct for difference in collection time; and
   calculate surface gradient and albedo for each point on the pavement surface.

Further features of the invention will be evident from the following description of preferred embodiments.

### BRIEF DESCRIPTION OF THE DRAWINGS

FIG. 1 is a block schematic of the photometric scanning system;

FIG. 2 illustrates the array illumination system showing the 4 different lighting conditions;

FIG. 3 gives further details on the array illumination system;

FIG. 4 illustrates the method of deriving the surface gradients and albedo from the four illumination images;

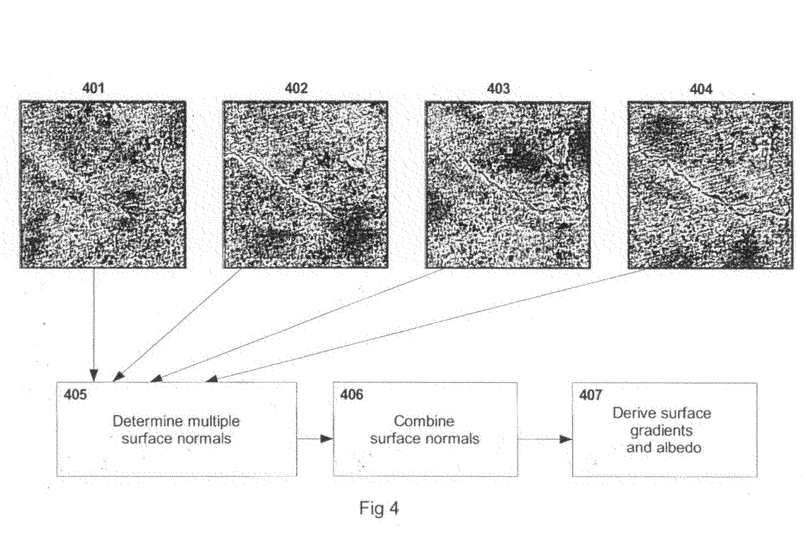

FIG. 5 is a block schematic of the post processing scheme used for the photometric scanning system; and

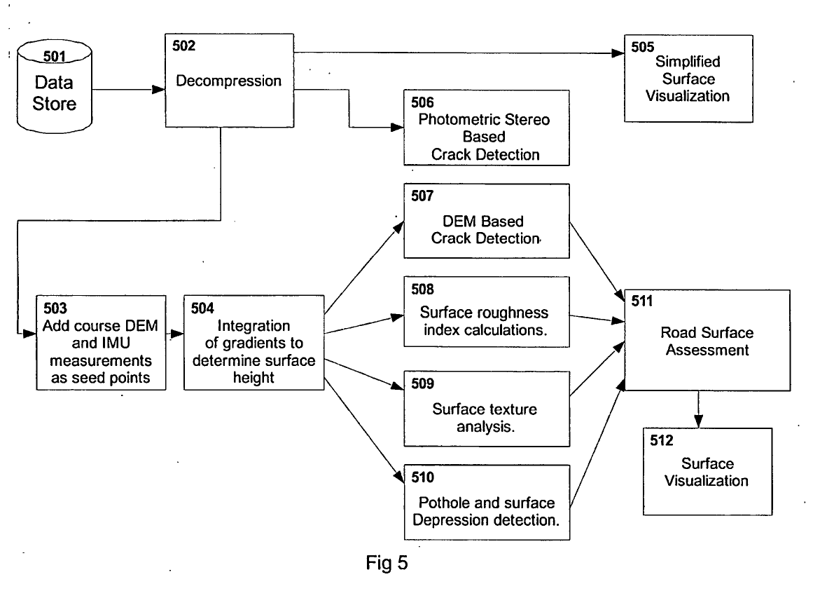

FIG. 6 illustrates the method of aligning the four images taken of the road surface, so that they appear as if they are collected at the same time.

FIG. 7 illustrates an alternate approach for the proposed system where multiple linescan cameras and a rotating laser distance measurement system is used.

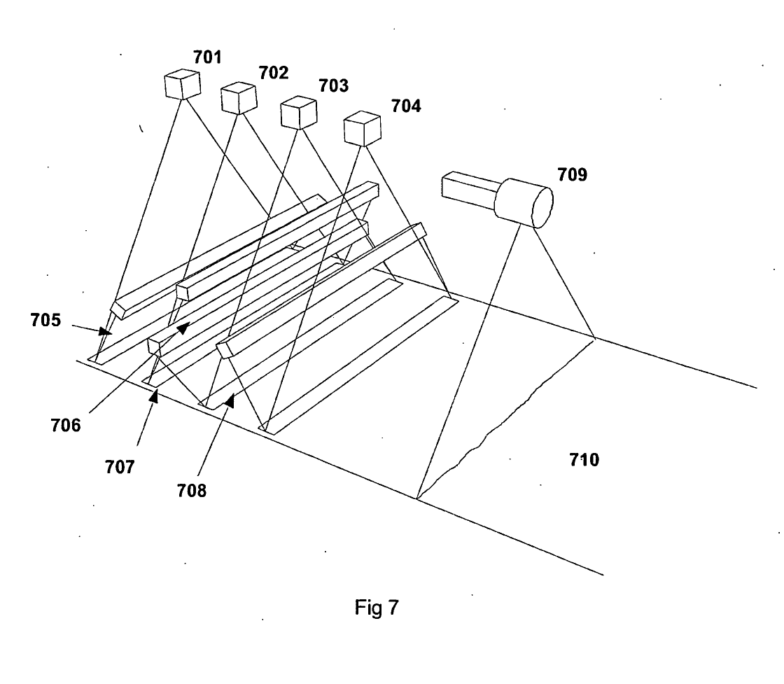

FIG. 8 illustrates the proposed system where multiple laser illumination sources are used as an alternative to the led based light sources.

### DETAILED DESCRIPTION OF THE INVENTION

The invention is an apparatus and method for collecting a very high resolution digital elevation map and albedo (reflectance) of a surface, at high speed. The purpose of the system is to collect information that allows a more accurate measurement of a road pavement surface. This can then be used to automatically assess road condition, such as cracking, rutting and surface texture.

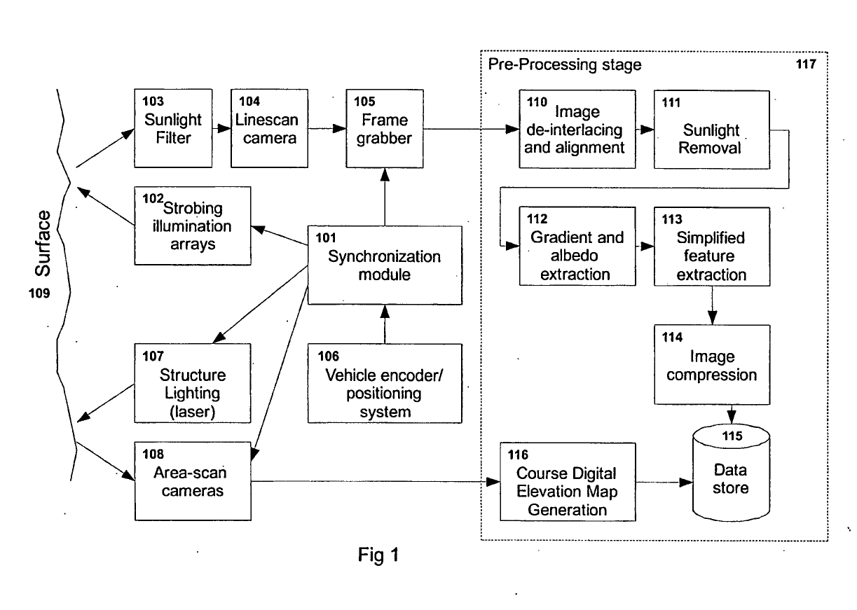

The proposed system is mounted to a vehicle and comprises a number of elements. FIG. 1 shows a block diagram of these elements:
1) An image capture device which may be a high speed line scan camera 104 and frame grabber 105,
2) A number (suitably four) high brightness array illumination units 102,
3) An encoder mounted to the vehicle allowing movement detection 106,
4) A synchronization module 101,
5) A low resolution digital elevation map (DEM) collection system, such as a structured lighting 107 with a camera system 108. This could alternatively be a LIDAR based laser scanning system.
6) A data collection and processing means 117.

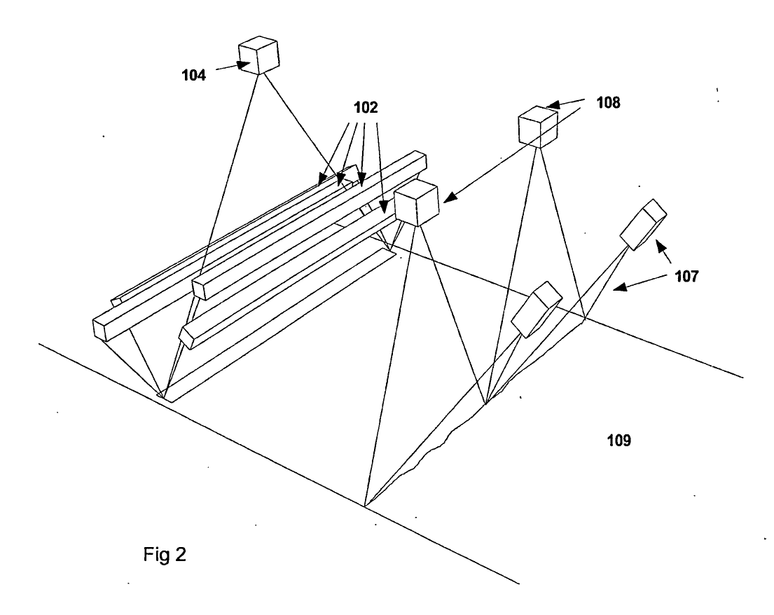

The image capture device may be a single integrated unit or a separate high speed line camera 104 and frame grabber 105. The high speed line scan camera 104, in combination with a sunlight filter 103, collects 3.75 meter wide images of the road surface 109 at high resolution, using a frame grabber card 105. This is linked to a set of four illumination arrays 102, via a synchronization module 101. The illumination arrays consist of a number of high brightness LEDs. Each lighting array shines four different lines of light on the surface, each from a different angle. FIG. 2 shows the mechanical configuration of the linescan camera relative to the illumination arrays and the DEM generation system 116.

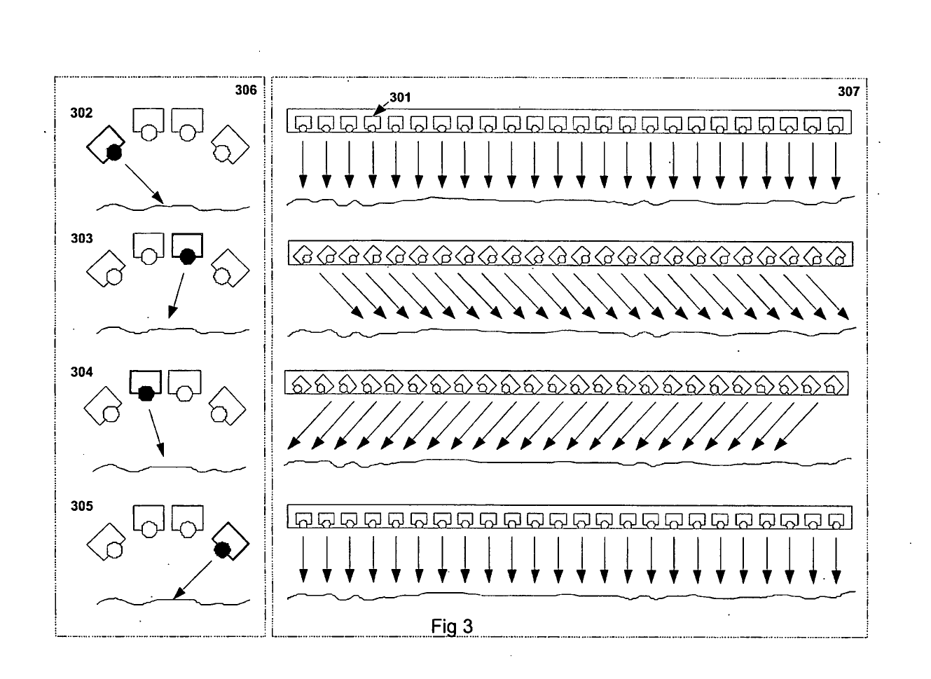

FIG. 3 shows the orientation of each of the lighting arrays, both from the side 306 and from the back 307 of the vehicle. In the first array 302, each of the individual LEDs 301 are pointing at 45 degrees from the front of the vehicle. For the second array 303, the LEDs are pointing 45 degrees from the left side. For the third array 304, the LEDs are pointing at 45 degrees from the right. Finally, for the forth array 305 the LEDs are pointing at 45 degrees from the back of the vehicle.

As the vehicle travels forward, the led arrays are flashed in order, each time collecting a line of resultant reflected light using the line scan camera 104, which is then digitized using the frame grabber card 105. Specialized LED driving circuitry allows the LEDs to be flashed at the high speeds required. The resultant image collected by the image capture device is a set of four interlaced images from each of the different lighting directions. This composite image is separated into four images of the surface illuminated from the different lighting arrays. Special consideration is required to ensure a consistent illumination from the lighting system.

One alternative to using one linescan camera and then flashing four sets of led lighting units is to use four slower speed linescan cameras 701, 702, 703 and 704, each with its own dedicated led lighting array, 705, 706, 707 and 708. With this approach, the lighting units no longer need to be flashed. Care however needs to be made to ensure that the linescan cameras are positioned and triggered accurately.

Another alternative is to use a laser based illumination system. In this approach a linescan camera 801 is aligned with two laser modules, one to the right of the linescan camera 802 and one to the left 803. Each of the laser modules has a line generating optics to produce a narrow line of laser light over the road surface. Extreme care is required to ensure that the laser modules are in the same plane as the linescan camera optics. This configuration does not allow front and back illumination, as this would not be in the same plane as the linescan camera. As a result, this technique can only estimate the gradient of the surface across the road. A sunlight filter is used to allow the laser line to the received, while limiting the amount of disturbance from sunlight As the vehicle moves the lighting units are flashed in sequence, to produce two images of the road surface, one with the illumination from the left and the other with the illumination from the right.

A synchronization module 101 is used to control the data collection allowing images to be collected independent of vehicle speed. This is achieved using an encoder or vehicle speed sensor 106, connected to the drive train or directly to the wheel. Based on this input, the synchronization module sends pulses to the image capture device and lighting system. A pulse is generated every 0.91 mm of travel, which then triggers the capture of four lines by the image capture device, cycling through each of the four lighting units in rapid succession.

The images are digitized using a frame grabber card 105, pre-processed 117 and then saved to hard-drive 115. At this state, image de-interlacing and alignment 110, sunlight removal 111, gradient and albedo extraction 112 and simplified feature extraction 113, and image compression 114 can be performed. Alternatively these steps can be done in a post processing stage.

The first step in the pro-processing module is image de-interlacing and alignment 110. De-interlacing involves taking alternate lines from the composite image produced by the image capture device, to form four images of the road surface due to each of the four lighting directions.

The next step is image alignment. This is required because each of the lines from the linescan camera is collected at different times, resulting in a slight shifts in each of the images due to the movement of the vehicle. At slow speeds the difference is minimal, due to the slow movement of the vehicle in comparison to the rate of image collection. However at high speed, this shift in the image can be as much as 0.45 mm (half a pixel). To obtain accurate photometric gradient estimates, it is important that this error be corrected.

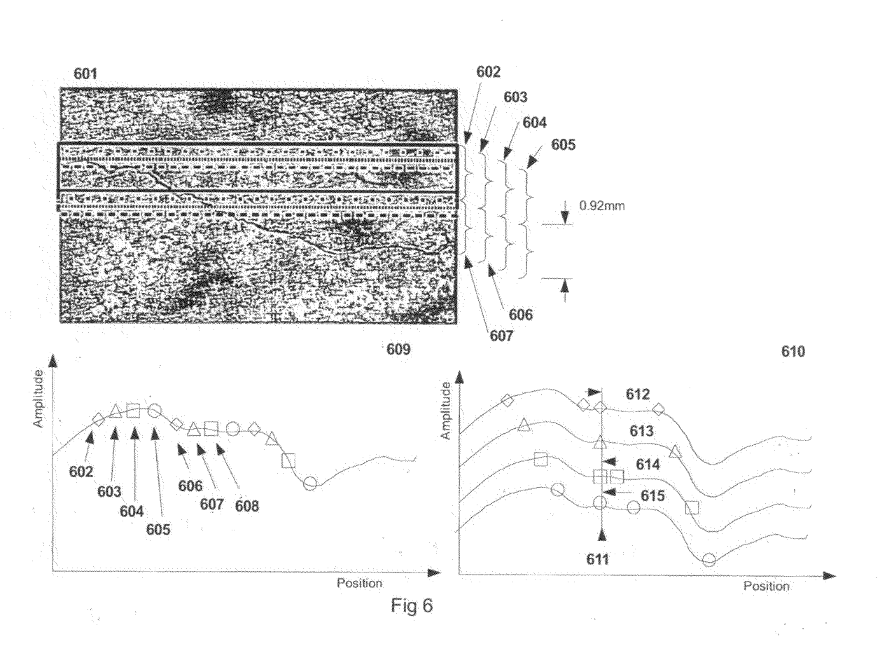

FIG. 6 illustrates the image alignment problem in more detail. In this example, the first line 602 collects a line of points on the road at a specific time. Later, with a different lighting direction a second line is collected 603. This continues, producing a number of lines in the resultant image 604, 605, 606, 607, 608, repeating through each of the four lighting modules every four lines. To obtain accurate photometric gradient estimates, it is essential to align these differently located lines. It is corrected using one image as a reference and then use cubic interpolation to estimate unshifted versions of each of the remaining images at the same point in time 611 as the reference image. In FIG. 6, this is illustrated for one point within the line, with the left image showing the data prior to image alignment 609. In the alignment step 610, one image will be moved forward by ¼ of a pixel 612, one will be kept the same, 613 and the last two images will be moved ¼ and ½ of a pixel backwards 614 and 615. Instead of using cubic interpolation, sinc wave interpolation can also be used. After this alignment step the photometric stereo technique can be accurately applied.

The next step 111 is to reduce the effect of sunlight within the images. Initially shades and a sunlight filter on the linescan camera reduce the effects of sunlight as much as possible. However to obtain good contrast images with accurate gradient estimates, further reduction of the effects of sunlight is often necessary. This is primarily required on the edges of the images where shading is not possible, due to the vehicles maximum width of 2.5 m. To rectify this problem, an ancillary image can be taken of the surface with no artificial lighting, only sunlight. This image with only sunlight illuminating the surface is then used to remove the effect of sunlight in the other images collected by the system. This is performed after each of the images has been aligned, as described previously. By subtracting the sunlight only image from the original images a sunlight free images can be produced. This technique also removes the effect of imaging sensor DC bias.

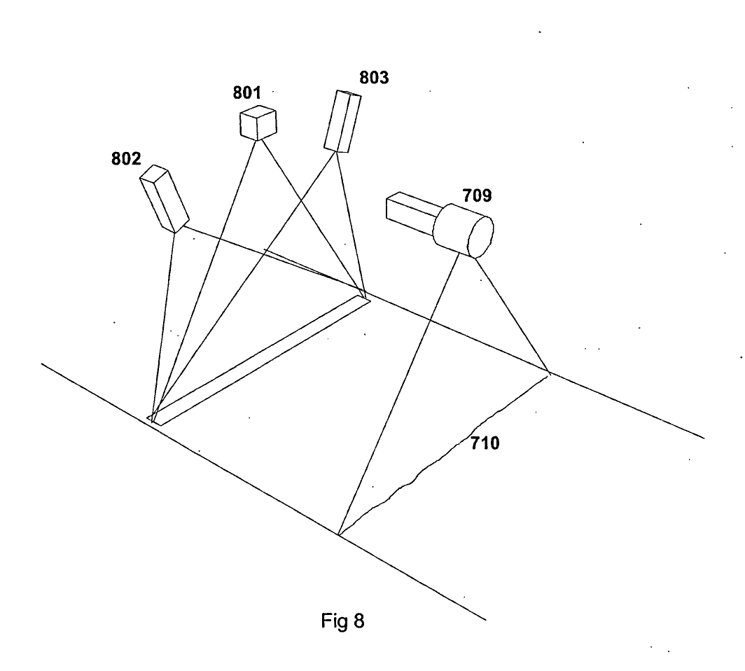

An alternative configuration employs multiple image capture devices that are paired with the multiple lightsources. In the example given in FIG. 8, there are four linescan cameras (Each image capture device captures an image when the scene is illuminated by a particular lighting source.

Once the principle system and external artifacts have been removed from the images, the technique of photometric stereo may be applied to the data 112. This produces localized estimates of the surface gradients and albedo (or reflectance) for each pixel in the image. Within the center of the scan, where four lighting sources are available, the preferred technique used a four light source photometric stereo technique, where the three highest amplitude images are used to reduce the chance of an area being in shadow. On the edges of the images, where only three lighting sources are available, due to system width constraints, the standard three light source photometric stereo technique is used.

As explained previously, the following steps are performed:
a) For each given point (x, y) on the surface, the image intensity vector I is firstly formed by capturing four images under different illumination directions L₁, L₂, L₃ and L₄ when possible 401, 402, 403 and 404.
b) When four lighting directions are available, the four versions of the vector M=[m₁, m₂, m₃]^{T} are obtained by the production of the four different combinations of intensity vectors, I and their respective illumination matrix L⁻¹. When only three lighting directions are available, only one vector M is calculated 405.
   where
I=[i₁, i₂, i₃]^{T} is image intensity vector;
L=[L₁, L₂, L₃]^{T} is photometric illumination matrix which incorporates the light intensity for each light source.
c) If four vectors have been calculated, they are then summed to produce an average vector 406. When one of the images is in shadow, the calculated vectors that include this shadowed image will be of low amplitude, so the summed vector will be predominately influenced by the non-shadowed illumination values. The result is more resistant to image distortion associated with shaded regions. Further analysis to identify and remove glossy reflection can also be done at this point.
   If gradients are required, the following steps can also be applied 407.
d) The surface gradient components can be calculated via

p=−m₁/m₂ and q=−m₂/m₃
e) Finally, the surface albedo is recovered by finding the length of vector M.

p=sqrt(m₁²+m₂²+m₃²)

As the system is required to operate at high speeds, often a large proportion of the image processing is performed through post processing of the data. At the post processing and extraction stage, the recorded data is retrieved from a data store 501, decompressed 502, and then passed to a number of modules.

In one module, the data produced can be displayed directly to the user using a bump-mapping technique, where the vector M is used in combination with a lighting direction vector. By allowing the user to move the lighting direction vector within a virtual environment, it is possible to visually recreate the surface texture to the user 505.

The surface gradients and albedo can be used directly to determine road features such as cracking, where the algorithms are run directly on the gradient and intensity data 506. Through working with the direct measurements, rather than the more difficult to reconstruct surface elevation map, it is possible to improve,crack detection, in contrast to the use of a single camera image with lighting from only one direction. Cracks are identified both in the gradient and intensity images. Both the shape and intensity is then used to classify the features as cracks, sealed cracks or other road features. The main advantages over single image classification of cracking, is the ability to eliminate false targets such as dark marks on the road. An example is an oil spill (which is often incorrectly identified as a crack), as it will only appear within the intensity image, not the gradient images. It also improves the identification of other surface features that could lead to false positives, such as road markings, wheel marks, sticks and other road debris.

Another highly useful element of the system is the ability to identify sealed cracks. Cracks are often sealed using bitumen, which to a normal surface image camera still appear as a dark line within the image. With the photometric stereo technique it is possible to detect the presence of the flat bitumen surface in contrast to the depression caused by an unsealed crack.

It is often necessary to convert the gradients to a full digital elevation map (DEM) of the surface being studied. This allows both the large and small scale changes in the surface to be assessed. To achieve this the gradients need to be integrated in two dimensions. The techniques to achieve this can be broadly classified into local integration techniques and global integration techniques. While local integration techniques are computationally more efficient, multiple paths need to be used to minimize errors. Global techniques instead treat the entire region as a optimization problem.

Simply using the gradient estimates alone has errors which increase proportionally to the distance between two points. As a result the technique of photometric stereography is only useful for determining the DEM in localized regions. It is also prone to errors produced by lighting inconsistencies both within a lighting array and between lighting arrays.

To improve the accuracy of the generated DEM, it is advantageous to combine the gradient integration technique with a system that generates a course DEM of the road pavement. Ideally the course DEM generation system produces a number of seed points, whose location and height is precisely known. The photometric stereography data is then used to fill the gaps between these more precisely known points.

There are a number of techniques that can be used to produce these seed points. One technique is to use a laser line that is projected across the full width of the road surface 109. This is angled relative to the camera that collects images of the laser line at high speed 108. Through the use of triangulation, the position of the laser line in the collected image is then used to determine the height of the pavement surface. Another technique is to use a LIDAR (Light Detection And Ranging) based profiling system 709, where a laser distance measuring unit is scanned across the road surface 710 using a rotating mirror. Both techniques also required accurate detection of the vehicles movement, which can be achieved through the use of an inertial measurement unit (IMU), coupled to a GPS system to allow accurate geolocating of the data.

To produce an accurate high resolution DEM, the course DEM measurements then need to be combined with the gradient estimates produced by the photometric imaging system 503. One method of achieving this is to take two of the lines produced by the laser line imaging sensor. The gradient estimates produced using the photometric stereo method can then be locally integrated between the two lines to produce a high resolution DEM of the surface. The other option is to use global integration methods, but with weightings to allowing the integration of the seed points collected by the course resolution DEM system 504.

The use of a course DEM system is also very useful in correcting for lighting inconsistencies between lighting arrays, as well as vehicle bounce. Vehicle bounce can move the captured surface to a different part of the illumination pattern from a lighting array, causing a slight reduction in the intensity of the image collected. These effects normally occur at a slower rate than the laser line profiling sensor readings. This would normally result in a bias in the assumed gradient for all of these points within this region. However when combined with the course DEM system, this bias is removed. The result is a set of images free from the effects of these lighting inconsistencies.

Once the high resolution DEM is derived, the resultant information can be used in a number of ways. These include and are not limited to:
1) Identification of surface cracking (both sealed and unsealed) 507.
2) Extraction of road roughness 508.
3) Identification of areas with low texture depth, which can be due to asphalt bleeding or polishing 509.
4) Identification of pot holes, raveling and stripping 510.
5) Identification of areas where there is surface depression or corrugation which can indicate areas of high moisture or voiding 510.
6) Extraction of the road cross profile allowing measurement of the amount of rutting.
7) Surface comparison between scans, allowing detection of surface change with time.
8) Identification and removal of spurious road targets such as sticks and other debris, which can confuse crack detection algorithms.
9) Identification of patches.
10) Identification of areas of water bleeding.

Through the automatic identification and classification of each of these features, an assessment of the road surface condition can be made 511. The high resolution DEM can also be displayed directly 512.

### VARIATIONS

It will be realized that the foregoing has been given by way of illustrative example only and that all other modifications and variations as would be apparent to persons skilled in the art are deemed to fall within the broad scope and ambit of the invention as herein set forth.

Throughout the description and claims to this specification the word “comprise” and variation of that word such as “comprises” and “comprising” are not intended to exclude other additives, components, integrations or steps.

1. A pavement scanning system comprising:
a movable platform;
multiple light sources mounted on the platform for illuminating a pavement surface from multiple different angles;
at least one image capture device mounted on the platform that captures sequential images of the illuminated pavement surface;
a movement sensor that encodes movement of the platform and provides a synchronisation signal for synchronising the multiple light sources and the at least one image capture device for multiple image capture; and at least one processing means that:
resamples the multiple captured sequential images to compensate for difference in collection time; and
calculates surface gradient and albedo for each point on the pavement surface or directly uses the multiple images to detect surface features.

2. The pavement scanning system of claim 1 wherein the multiple light sources are light emitting diodes.

3. The pavement scanning system of claim 1 wherein the multiple light sources are lasers with line generating optics.

4. The pavement scanning system of claim 1 wherein there is a single image capture device and multiple flashable light sources.

5. The pavement scanning system of claim 1 wherein there are multiple image capture devices and multiple light sources.

6. The pavement scanning system of claim 1 further comprising a synchronisation module that receives a signal from the movement sensor and provides a control signal to the multiple light sources and the at least one linescan camera to synchronise the at least one linescan camera with the multiple light sources for capture of an image.

7. The pavement scanning system of claim 1 wherein the processing means comprises a digitiser for digitising the captured images.

8. he pavement scanning system of claim 1 further comprising a processing means that performs feature detection oil the calculated surface gradient and albedo to identify regions of pavement non-conformance.

9. The pavement scanning system of claim 1 further comprising a data storage device.

10. The pavement scanning system of claim 1 further comprising a digital elevation map generation system.

11. The pavement scanning system of claim 0 wherein the digital elevation map generation system comprises a laser line generator and high speed camera.

12. The pavement scanning system of claim 9 wherein the digital elevation map generation system comprises a scanning laser distance sensor.

13. The pavement scanning system of claim 9 further comprising a processing means that uses a digital elevation map generated by the digital elevation map generation system to improve an accuracy of the surface gradient.

14. The pavement scanning system of claim 1 further comprising a sunlight filter.

15. The pavement scanning system of claim 1 further comprising an optical diffuser.

16. A method of detecting pavement deterioration including the steps of:
illuminating a pavement surface from multiple angles with multiple light sources;
capturing images of the illuminated surface;
synchronising image capture with the surface illumination;
processing the captured images to:
correct for difference in collection time; and
calculate surface gradient and albedo for each point on the pavement surface.

17. The method of claim 16 further including the step of recording the captured images for later processing.

18. The method of claim 16 further including the step of generating a digital elevation map and correcting the surface gradient with the digital elevation map.
